(19) United States
(12) Patent Application Publication
(10) Pub. No.: US 2011/0218822 A1
(43) Pub. Date: Sep. 8, 2011

(54) REMOTE PATIENT MANAGEMENT SYSTEM ADAPTED FOR GENERATING A TELECONSULTATION REPORT

(75) Inventors: Harm Jacob BUISMAN, EINDHOVEN (NL); Aleksandra TESANOVIC, EINDHOVEN (NL)

(73) Assignee: KONINKLIJKE PHILIPS ELECTRONICS N.V., EINDHOVEN (NL)

(21) Appl. No.: 13/028,239

(22) Filed: Feb. 16, 2011

Related U.S. Application Data
(60) Provisional application No. 61/310,404, filed on Mar. 4, 2010.

(51) Int. Cl. G06Q 50/00; G06Q 10/00

(52) U.S. Cl. 705/3; 705/2

(57) ABSTRACT

The invention provides for a remote patient management system comprising a computing device. The computing device comprises a processor and a computer readable storage medium. The computer readable storage medium contains instructions that when executed cause the processor to perform a method of generating a teleconsultation report. The method comprises the step of recording a teleconsultation between a health professional and a patient using a microphone. The method further comprises the step of converting the recording of the teleconsultation into a text file. The method further comprises the step of parsing the text file into tokens. The method further comprises the step of filling a teleconsultation parse tree using the tokens. The teleconsultation parse tree has nodes arranged in a tree like structure. The method further comprises the step of generate the teleconsultation report using the teleconsultation parse tree.

### TECHNICAL FIELD

The invention relates to remote patient management systems, in particular to remote patient management systems comprising a computer readable storage medium containing instructions for performing a method of generating a teleconsultation report

### BACKGROUND OF THE INVENTION

Teleconsultations, such as nurse interventions over the phone and with the patient at a remote location, are becoming increasingly used for out-patient management, especially for chronic diseases. The goal of a teleconsultation is to remotely discuss with the patient issues that are most relevant for him, assess his condition and provide an intervention, which can comprise medication change and/or advices on lifestyle changes, or other health related education. Hence, the nurse, health care professional, or other care giver on the phone covers a number of topics that are relevant to patient condition educating the patient to understand what he is supposed to do when it comes to medication and lifestyle changes in order to ensure better compliance and thereby better clinical outcomes.

Teleconsultation can be supported by remote patient management (RPM) systems or done independently (with an RPM). RPM system helps the nurse by giving an overview of vitals and symptoms of the patients and indicating the potentially dangerous deviations (i.e., early detecting the worsening so that they can intervene to prevent hospitalizations), so she can detect the worsening in time and intervene earlier. In case when the RPM system is not available, the nurse on each teleconsultation pre-schedules the next teleconsultation based on the patient condition during the given consultation.

United States patent application US 2009/0089096 A1 discloses an apparatus comprising a computer program product comprising instructions for establishing telephone based communication between a consumer of medical services and a provider of medical services based upon a request from the consumer of medical service to consult with a medical provider. The instructions further comprise establishing a record based upon the communication. This application further discloses that after the consumer disconnects from the telephone based communication, the provider is prompted to furnish an audio message related to the telephone-based communication. The instructions further comprise receiving and recording the audio message from the provider, and associating the audio message with the established record. This application further discloses the transcription of telephone-based communication using voice recognition software.

### SUMMARY OF THE INVENTION

For a teleconsultation, the care giver or healthcare professional spends significant amount of his or her time to prepare, conduct and report these consultations. The amount of work spent on these tasks limits the number of patients that a care giver can address during the day. Even with the use of remote patient management (RPM) systems, teleconsultations are still the most time-consuming activities of the care givers. Embodiments of the invention may use speech to text conversion, natural language processing, and ontology matching to automatically generate a summary report of a teleconsultation. Ontology matching may also be referred to as syntactic analysis. Embodiments of the invention may potentially be used to support health care professionals in the preparation, execution, reporting, and follow-up of a teleconsultation. Embodiments of the invention may save time in the clinical workflow of up to 50%.

A ‘computing device’ as used herein refers to any device comprising a processor. A processor is an electronic component which is able to execute a program or machine executable instruction. References to the computing device comprising “a processor” should be interpreted as possibly containing more than one processor. The term computing device should also be interpreted to possibly refer to a collection or network of computing devices each comprising a processor. Many programs have their instructions performed by multiple processors that may be within the same computing device or which may even distributed across multiple computing device.

A ‘computer readable storage medium’ as used herein is any storage medium which may store instructions which are executable by a processor of a computing device. In some embodiments, a computer-readable storage medium may also be able to store data which is able to be accessed by the processor of the computing device. An example of a computer-readable storage medium include, but are not limited to: a floppy disk, a magnetic hard disk drive, a solid state hard disk, flash memory, a USB thumb drive, Random Access Memory (RAM) memory, Read Only Memory (ROM) memory, an optical disk, a magneto-optical disk, and the register file of the processor. Examples of optical disks include Compact Disks (CD) and Digital Versatile Disks (DVD), for example CD-ROM, CD-RW, CD-R, DVD-ROM, DVD-RW, or DVD-R disks. The term computer readable-storage medium also refers to various types of recording media capable of being accessed by the computer device via a network or communication link. For example a data may be retrieved over a modem, over the internet, or over a local area network.

‘Computer memory’ as used herein is an example of a computer readable storage medium. Computer memory is any memory which is directly accessible to a processor. Examples of computer memory include, but are not limited to: RAM memory, registers, and register files.

‘Computer storage’ as used herein is an example of a computer readable storage medium. Computer storage is any non-volatile computer-readable storage medium. Examples of computer storage include, but are not limited to: a hard disk drive, a USB thumb drive, a floppy drive, a smart card, a DVD, a CD-ROM, and a solid state hard drive. In some embodiments computer storage may also be computer memory or vice versa.

A ‘remote patient management system’ as used herein is a system for remotely administering a care plan. A care plan is a day-to-day plan for managing a disease or health condition.

A ‘content element’ as used herein is content which may be provided to a patient and which may be integrated into a care plan for the patient. For instance a remote patient management system may present content elements for education or motivating a patient.

A ‘care plan’ is a day-to-day plan for managing a disease or health condition. Content elements may be provided either by a hospital or an outpatient clinic or a disease management organization or a remote patient management system.

A ‘home infrastructure device’ as used herein is a device adapted for delivering the content element and the assessment content element to the patient. The home infrastructure device comprises at least one diagnostic medical device for measuring a value of a patient's vital sign.

The term ‘vital sign’ as used herein refers to are any physical property of the patient which may be measured. Examples of vital signs include, but are not limited to: weight, blood sugar level, blood pressure, pulse, SpO2, and bio-impedance

A ‘teleconsultation’ as used herein consultation between a healthcare professional and a patient that is conducted using telecommunications or communications equipment. A teleconsultation may be performed remotely via telecommunications. For example, a teleconsultation may be conducted via, but not limited to: telephone, radio, voice of internet protocol, teleconferencing equipment, cellular telephone, or video calling, other telecommunications medium. Teleconsultation is typically performed with the healthcare professional and the patient being at separate locations. In this case the telecommunications equipment is needed for the healthcare professional and the patient to communicate. However, a teleconsultation may also be performed if the patient and the physician are within audible distance from each other. In this case the telecommunications equipment is not used for the communication between the patient and the physician, but is instead used to record the speech of the patient and the physician during the teleconsultation.

A ‘teleconsultation report’ as used herein refers to a summary of a teleconsultation.

A ‘teleconsultation outline’ as used herein is an outline or transcript which is prepared for a healthcare professional to use during a teleconsultation. A ‘teleconsultation outline’ may be an outline or graphically displayed nodes which outline the predetermined contents of a teleconsultation.

A ‘token’ as used herein is a subset of a text file which has been divided into meaningful groups of characters. A token is a meaningful group of characters. For example when parsing the text file into tokens individual words with their part of speech may be identified. Once the text file has been parsed into tokens a pattern recognition or a syntactic analysis may be performed to create a tree which indicates the structure of the text file which has been parsed into tokens.

A ‘health professional interface’ as used herein is a user interface for a computing device which allows a health professional to control and/or interact with a remote patient management system.

A ‘patient interface’ as used herein is a user interface for a computing device which allows a patient to interact and/or receive a content element from a remote patient management system.

The invention provides for a remote patient management system comprising a computing device. The computing device comprises a processor. The computing device further comprises a computer readable storage medium containing instructions that when executed cause the processor to perform a method of generating a teleconsultation report. The method comprises the step of recording a teleconsultation between a health professional and a patient using a microphone. The health professional and the patient may be at the same location and a single microphone may be used or the health professional and the patient may be at separate locations. As used herein reference to a microphone in the claim can refer to either a single microphone for recording both the health professional and a patient or microphones at different locations for recording the health professional and the patient.

The method further comprises the step of converting the recording of the teleconsultation into a text file. The conversion of the recording of the teleconsultation into a text file may be achieved by using speech recognition software. In one embodiment the speech recognition software is able to distinguish between the health professional and the patient.

In another embodiment the speech recognition software is able to distinguish between the health professional and the patient by using more than one microphone. For instance the health professional and the patient could have their voices recorded separately. In another example one microphone could record both the health professional and the patient and another microphone could record either the health professional or the patient. Using more than one microphone would allow speech by the health professional and speech by the patient to be distinguished.

The method further comprises the step of parsing the text file into tokens. For parsing the text file into tokens a lexical analysis may be performed.

The method further comprises the step of filling a teleconsultation parse tree using the tokens. The filling of the teleconsultation parse tree may be achieved using syntactic analysis. The teleconsultation parse tree may be created on the fly using the parsed text. In other embodiments knowledge of the topics covered in the teleconsultation may be used to at least partially create a teleconsultation parse tree which is then filled using the tokens. Knowledge of the topics covered in the teleconsultation may be provided by the healthcare professional and/or a teleconsultation outline.

Filling a teleconsultation parse tree refers to the process of placing the tokens in a meaningful tree-like structure. The teleconsultation parse tree has nodes arranged in a tree-like structure. The tokens may either be arranged into nodes or may be used to annotate nodes.

The method further comprises the step of generating the teleconsultation report using the teleconsultation parse tree.

In another embodiment the remote patient management system further comprises a home infrastructure device. The home infrastructure device comprises at least one diagnostic medical device for measuring a value of a patient vital sign. The method of generating a teleconsultation report is initiated when the value of a patient vital sign is outside of a predetermined range. This embodiment is beneficial because the home infrastructure device can monitor one or more vital signs in a patient and can automatically initiate a teleconsultation if the vital sign is outside of a predetermined range. This embodiment is advantageous because the remote patient management system may continually monitor the patient and can alert health professionals by initiating generation of a teleconsultation report. For instance a patient which has a heart condition and is on a low sodium diet may be harmed if he or she eats a large amount of salt. The patient's sodium intake may be assessed by a questionnaire which is delivered to the patient by the remote patient management system. The patient could, for instance, input foods that he or she ate into a patient interface of a home infrastructure device. If the patient for instance eats a pizza the remote patient management system may be able to determine that high levels of sodium have been consumed and initiate a teleconsultation with a health professional which allows the health professional to interview or provide a consultation the patient and explain healthy behavior to the patient.

The remote patient monitoring system further comprises a health professional interface. The health professional interface may, for instance, be the interface of the computing device. The health professional interface in another embodiment may also be a computer which is connected by a communication system to the computing device.

The method further comprises the step of displaying a teleconsultation outline on the health professional interface during the recording of the conversation. In some embodiments a teleconsultation outline may simply be outline form. In other cases the teleconsultation outline may provide text for questions to the healthcare professional in a way which is similar to a teleprompter. This embodiment is beneficial because it reduces the possibility of a health professional forgetting to ask a particular question from a patient.

In another embodiment the teleconsultation outline comprises questions and/or a list of topics to be discussed with the patient.

In another embodiment the teleconsultation parse tree is at least partially created using the teleconsultation outline. For instance if the remote patient management system is aware of which portion of the teleconsultation outline is being used by a health professional at a given time, then the speech of the health professional and/or the patient can be correlated to the teleconsultation outline. In this respect the syntactic analysis which is used to fill the teleconsultation parse tree can be augmented by the contents of the teleconsultation outline. This can be achieved in several different ways, for instance the teleconsultation outline can be used to create the parse tree at least partially and by this the teleconsultation outline can be used to create some or all of the nodes of the parse tree in advance. In addition a syntactic analysis of the tokens may allow the creation of a teleconsultation parse tree by itself. In this case the teleconsultation outline can be used to annotate the nodes of the teleconsultation parse tree.

In another embodiment the remote patient monitoring system further comprises a patient record database with a patient record belonging to the patient. The patient record comprises a parse tree database. The parse tree database comprises a plurality of teleconsultation parse trees. The plurality of teleconsultation parse trees are teleconsultation parse trees from previous teleconsultations.

The method further comprises constructing a pre-consultation parse tree at least partially by combining a predetermined number of teleconsultation parse trees from the parse tree database. In this step a number of parse trees from previous consultations are combined into a pre-consultation parse tree.

The method further comprises the step of generating a teleconsultation outline using the pre-consultation parse tree. Teleconsultation parse trees from previous teleconsultations are stored in the parse tree database. A predetermined number of these teleconsultation parse trees are combined and then are used to create a teleconsultation outline which can be used by the healthcare professional for the teleconsultation. In some embodiments the patient record may comprise medical records of the patient. In some embodiments the medical records of the patient may also be used to create the teleconsultation outline. This embodiment is advantageous because the step of generating a teleconsultation outline from the plurality of teleconsultation parse trees is equivalent to reviewing past teleconsultations and using these past teleconsultations for generating an outline for a teleconsultation.

In another embodiment the method further comprises the step of adding the filled teleconsultation parse tree to the teleconsultation outline database. In this step the teleconsultation parse tree which was created by performing the method of generating a teleconsultation report is stored in the parse tree database.

In another embodiment the teleconsultations report is generated using a natural language generation system to convert the teleconsultation parse tree into the teleconsultation report. Natural language generation is the process of generating natural language from a machine-representable form. In this case the machine-representable form is the teleconsultation parse tree.

In another embodiment the method further comprises receiving edit data before generating the teleconsultation report. The edit data comprises instructions for editing the teleconsultation parse tree. The method further comprises the step of editing the teleconsultation parse tree using the edit data. The teleconsultation report may be a summary of the teleconsultation. A human operator may review the teleconsultation parse tree before the teleconsultation report is created. This may be achieved by examining the teleconsultation parse tree graphically on a graphical user interface of a computer display for instance. Modifications to the teleconsultation parse tree may be recorded using the graphical user interface which then is used to create edit data. This embodiment is advantageous because there may be errors or information which the medical professional does not wish to be in the teleconsultation report. In this way data can be adjusted, removed or added to the teleconsultation parse tree before the teleconsultation report is generated.

In another embodiment the patient management system further comprises a home infrastructure device. The home infrastructure device comprises at least one diagnostic medical device for measuring the value of a patient vital sign. The method further comprises measuring the effectiveness of the teleconsultation using the home infrastructure device. In this embodiment the effectiveness of the teleconsultation may be measured with the home infrastructure device by measuring the value of a patient vital sign or tracking the value of a patient vital sign over a predetermined value of time. For instance if the patient is a diabetic the effectiveness of a teleconsultation may be evaluated by monitoring the blood sugar level of the patient over a period of time. This is beneficial because it provides feedback to a health professional as to the effectiveness of the teleconsultation. It also can be used by a health professional to determine if another teleconsultation should be performed.

In another embodiment the effectiveness of the teleconsultation is measured at least partially by tracking the value of a patient vital sign for a predetermined amount of time.

In another embodiment the effectiveness of the teleconsultation is measured at least partially using a quiz. The quiz comprises questions at least partially selected using the teleconsultation parse tree. The method further comprises delivering the quiz to the home infrastructure device. In some embodiments the quiz may be incorporated as a content element into the care plan which is executed by the remote patient management system. The method further comprises presenting the quiz to the patient using the home infrastructure device. Presenting the quiz to the patient may be integrated into the care plan. The method further comprises scoring the quiz to measure the effectiveness of the teleconsultation. In some embodiments a survey is used instead of a quiz. In these embodiments the results of the survey are used to measure the effectiveness of the teleconsultation. This embodiment is advantageous because quizzes may be effective for determining how much patient knowledge has changed after a teleconsultation. It may also provide an encouragement for the patient to pay closer attention. When one knows that there will be a quiz and it will be scored the patient may be more attentive. In some embodiments the quiz is displayed to the patient before the teleconsultation. This gives the patient the opportunity to review and think about important questions before the teleconsultation.

In another embodiment the remote patient management system further comprises a home infrastructure device. The home infrastructure device comprises at least one diagnostic medical device for measuring a value of a patient vital sign. The method further comprises delivering educational content to the home infrastructure selected using the teleconsultation parse tree. The educational content may be content elements that are integrated into the care plan. This embodiment is advantageous, because the teleconsultation by the health professional is integrated into the care plan. This also enables the care plan to reinforce the counseling which was provided to the patient by the healthcare professional during the teleconsultation.

In another embodiment the recording of the conversation comprises at least two time-synchronized recordings. One of the time-synchronized recordings contains a recording of only one of the patient or the health care provider. This embodiment is advantageous because it allows the separation of which speech belongs to the patient and which speech belongs to the healthcare professional.

In another embodiment the parse tree is implemented in Extensible Markup Language (XML). This embodiment is particularly advantageous because Extensible Markup Language is a language which is easily designed for containing information with marking up its context. There exist off-the-shelf tools for parsing text into Extensible Markup Language and also converting data within Extensible Markup Language into natural language. Using Extensible Markup Language would facilitate and reduce the cost of implementing an embodiment of the invention.

In another embodiment the nodes are annotated nodes. This embodiment is advantageous because the annotation of the nodes can contain crucial information about the context of the information stored in and beneath the nodes.

In another aspect the invention provides for a computer readable storage medium having stored therein instructions which when executed by a computing device comprising a processor cause the computer device to perform a method of generating a teleconsultation report. The method comprises the step of recording a teleconsultation between a health professional and a patient using a microphone. The method further comprises the step of converting the recording of the teleconsultation into a text file. The method further comprises the step of parsing the text file into tokens. The method further comprises the step of filling a teleconsultation parse tree using the tokens. The teleconsultation parse tree has nodes arranged in a tree-like structure. The method further comprises the step of generating the teleconsultation report using the teleconsultation parse tree.

In another aspect the invention provides for a computer implemented method of generating a teleconsultation report. The method comprises the step of recording a teleconsultation between a health professional and a patient using a microphone. The method further comprises the step of converting the recording of the teleconsultation into a text file. The method further comprises the step of parsing the text file into the tokens. The method further comprises the step of filling a teleconsultation parse tree using the tokens. The teleconsultation parse tree has nodes arranged in a tree-like structure. The method further comprises the step of generating the teleconsultation report using the teleconsultation parse tree.

### BRIEF DESCRIPTION OF THE DRAWINGS

In the following preferred embodiments of the invention will be described, by way of example only, and with reference to the drawings in which:

FIG. 1 shows a flow diagram which illustrates a method according to an embodiment of the invention;

FIG. 2 shows a flow diagram which illustrates a further embodiment of a method according to the invention;

FIG. 3 shows a block diagram which illustrates a remote patient management system according to an embodiment of the invention;

FIG. 4 shows the workflow that a nurse goes through for preparing for a teleconsultation with a patient;

FIG. 5 shows a table which compares the method illustrated in FIG. 4 with a method according to an embodiment of the invention;

FIG. 6 shows a block diagram which illustrates a further embodiment of a remote patient management system according to the invention;

FIG. 7 illustrates the process of creating a text file from a log of a voice recording of a teleconsultation;

FIG. 8 illustrates how a conversation ontology is built or constructed;

FIG. 9 illustrates how a healthcare professional can edit the teleconsultation parse tree;

FIG. 10 illustrates the synthesis or generation of a teleconsultation report;

FIG. 11 illustrates how a teleconsultation outline may be constructed;

FIG. 12 illustrates how a pre-consult tree may be used to generate a teleconsultation outline;

FIG. 13 shows a block diagram which illustrates a further embodiment of a remote patient management system according to the invention;

FIG. 14 shows a block diagram which illustrates a further embodiment of a remote patient management system according to the invention; and

FIG. 15 shows a block diagram which illustrates a further embodiment of a remote patient management system according to the invention.

### DETAILED DESCRIPTION OF THE EMBODIMENTS

Like numbered elements in these figures are either equivalent elements or perform the same function. Elements which have been discussed previously will not necessarily be discussed in later figures if the function is equivalent.

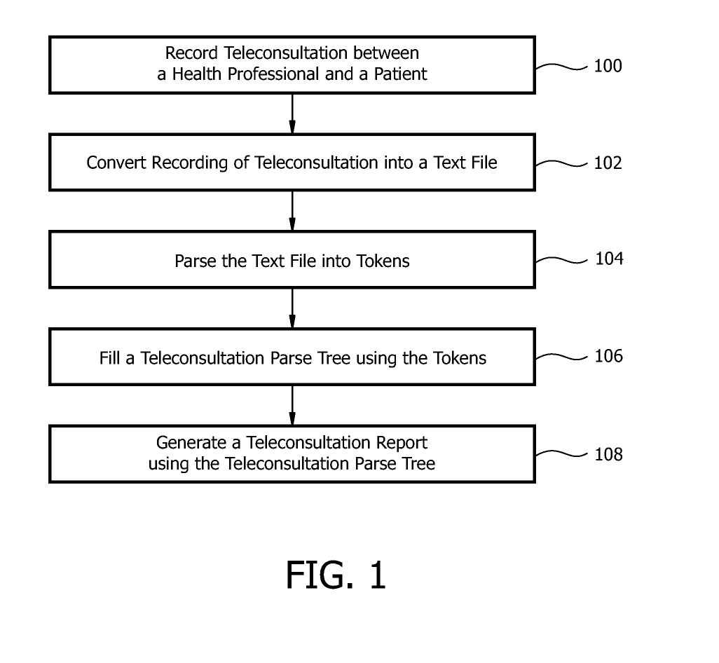

FIG. 1 shows a flow diagram which illustrates a method according to an embodiment of the invention. In step 100 a teleconsultation between a health professional and a patient is recorded. In step 102 the recording of the teleconsultation is converted into a text file. In step 104 the text file is parsed into tokens. In step 106 a teleconsultation parse tree is filled using the tokens. In step 106 the teleconsultation parse tree can be inferred by a syntactic analysis of the tokens or the teleconsultation parse tree can be determined before the syntactic analysis. In step 108 a teleconsultation report is generated using the teleconsultation parse tree.

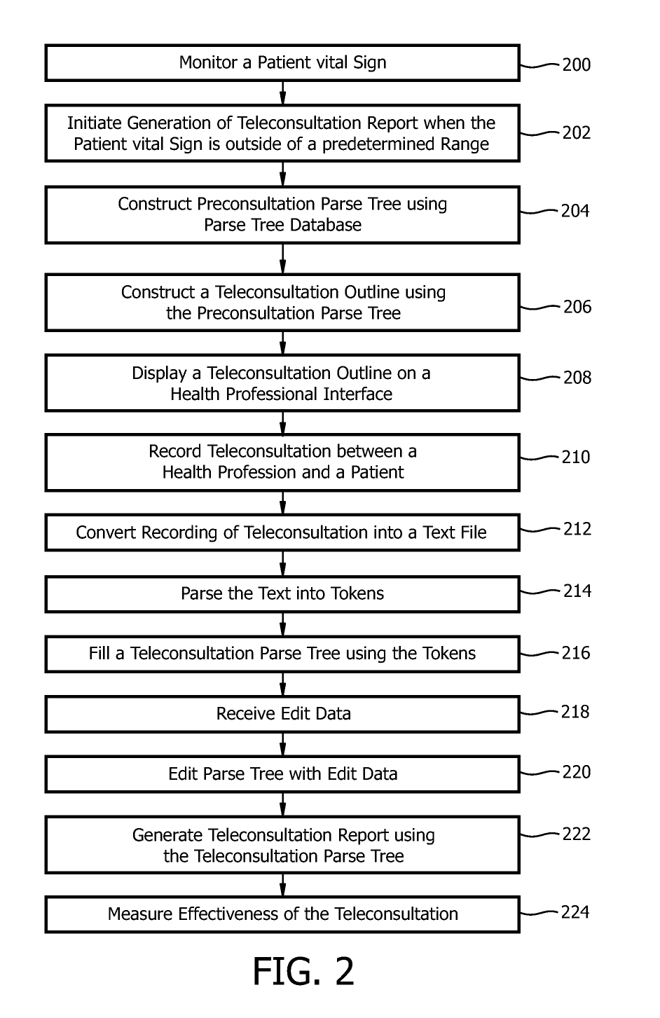

FIG. 2 shows a flow diagram which illustrates a further embodiment of a method according to the invention. In step 200 a patient vital sign is monitored. In step 202 the generation of a teleconsultation report is initiated when the patient vital sign is outside of a predetermined range. For instance the blood sugar of a diabetic could trigger a teleconsultation. The initiation of the teleconsultation may be completely automated by the computer or a healthcare professional could be alerted to the need for a teleconsultation. In step 204 a pre-consultation parse tree is constructed using a teleconsultation parse tree database. The teleconsultation parse tree database contains teleconsultation parse trees from previous teleconsultations. This step is equivalent to reviewing previous teleconsultations. In step 206 a teleconsultation outline is constructed using the pre-consultation parse tree.

In step 208 a teleconsultation outline is displayed on a health professional interface. The teleconsultation outline may be constructed as was illustrated in step 206 or the teleconsultation outline may be provided by a healthcare professional in some embodiments. In step 210 a teleconsultation between a healthcare professional and a patient is recorded. In step 212 the recording of the teleconsultation is converted into a text file. In step 214 the text file is parsed into tokens. In step 216 a teleconsultation parse tree is filled using the tokens. In step 218 edit data is received. Edit data is data which may be used to edit the structure or content of the teleconsultation parse tree. In step 220 the parse tree is edited with the edit data. In step 222 a teleconsultation report is generated using the teleconsultation parse tree.

In step 224 the effectiveness of the teleconsultation is measured. The effectiveness of the teleconsultation may be performed in several different ways. It may be performed by performing physical measurements on the patient. This could be performed using a diagnostic medical device interfaced with a home infrastructure device. The effectiveness of the teleconsultation may also be measured using quizzes and/or surveys.

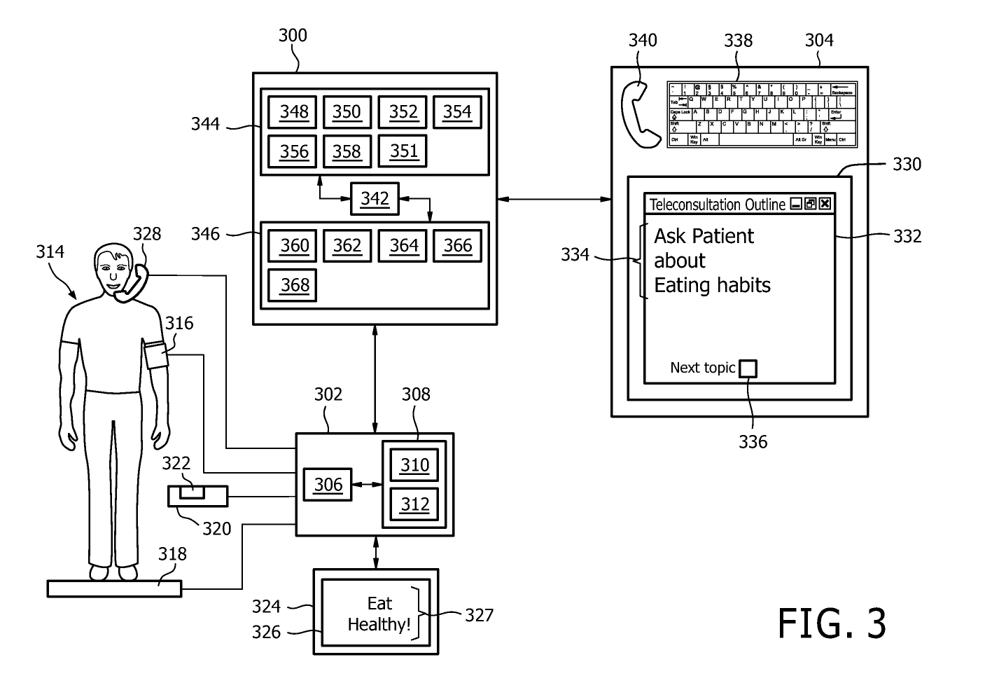

FIG. 3 shows a block diagram which illustrates a remote patient management system according to an embodiment of the invention. A computing device 300 is shown. The computing device 300 is connected to a home infrastructure device 302 and a healthcare professional interface 304. The computing device 300 may be connected to the home infrastructure device 302 and the healthcare professional interface 304 using a variety of interfaces. They may be connected by telephone, wireless LAN, radio, local area network, satellite link, and internet connection.

The home infrastructure device 302 comprises a processor 306. The processor 306 is connected to computer memory 308. The computer memory 308 comprises a care plan 310. The care plan contains machine executable instructions for controlling the operation of the home infrastructure device. The computer memory 308 may also contain one or more content elements 312. The content elements 312 may be multimedia information provided for a patient 314 or it may also be a survey or quiz generated according to an embodiment of the invention.

The home infrastructure device 302 may be connected to one or more diagnostic medical devices. In this example the patient 314 is shown as having a blood pressure cuff 316 for measuring the blood pressure of the patient 314. The weight of the patient 314 may also be weighed using a scale 318 which is interfaced to the home infrastructure device 302. There is also a blood sugar measurement device 320 which has a receptacle 322 for receiving blood from the patient 314. The home infrastructure device 302 is interfaced to these diagnostic medical devices 316, 318, 320 and is able to log measurements of these diagnostic medical devices 316, 318, 320 in the computer memory 308 or communicated back to the computing device 300.

The home infrastructure device 302 may also comprise a patient interface 324. With the patient interface the patient 314 is able to interact with the home infrastructure device. The patient interface may for example comprise a display 326. The display 326 may be able to display visual content elements such as text or messages 327. A telephone or microphone 328 is also shown as being connected to the home infrastructure device 302. The microphone 328 may be a part of the patient interface 324 or it may be a separate component. For instance the microphone 328 may be a telephone which connects to the computing device 300 separately or may be routed through the home infrastructure device 302.

The healthcare professional interface 304 attached to the computing device 300 may be a standalone computer or it may simply be the user interface of the computing device 300. For instance the computing device and the healthcare professional interface may be at the same location. Another alternative is that the healthcare professional interface 304 is at a location remote to the computing device 300. For instance the computing device 300 may be a laptop being used by the healthcare professional. In another embodiment the computing device 300 is a server which sits in a central location in a hospital. The healthcare professional interface 304 may be a separate computer which has a connection or data transfer interface to the computing device.

In the embodiment shown in FIG. 3, the healthcare professional interface 304 comprises a display 330. On the display a graphical user interface 332 is shown. The graphical user interface 332 displays the teleconsultation outline. The teleconsultation outline may be presented in outline form in some embodiments. In this embodiment text 334 is displayed on the graphical user interface 332. When the healthcare professional is finished with this topic which displayed in the text 334, there is a button 336 that the healthcare professional may click with a mouse. When button 336 is clicked the teleconsultation outline displays the next topic or information that the healthcare professional should discuss with the patient 314. This embodiment is advantageous because the computer knows which topic the healthcare professional is discussing with the patient 314. When the button 336 is clicked the next topic is displayed. In this way the topics and the recording 348 may be correlated. Also shown within the healthcare professional interface 304 is a keyboard 338 and a telephone 340 or microphone.

The computing device 300 comprises a processor 342. The processor 342 is connected to computer storage 344 and computer memory 346. Shown in the computer storage is a recording 348 of a teleconsultation. Also stored in the computer storage is a text file 350 generated from the recording 348. Also stored within the computer storage 344 is a teleconsultation parse tree 352 which has been generated from the text file 350. Also stored within the computer storage 344 is a teleconsultation report 354 that was generated using the teleconsultation parse tree 352. Also shown within the computer storage 344 is a teleconsultation outline 356 which was generated before the teleconsultation and was used to generate the text 334 on the graphical interface 332. Also shown within the computer storage is a patient record database 358.

The computer memory 346 contains instructions for operation of the processor 342. There is an operation module 360 which comprises instructions for operating and controlling the operation of the remote patient management system. There is a speech recognition module 362 which is stored in the computer memory 346 and is used for converting the audio recording 348 into the text file 350. Also shown within the computer memory 346 is a lexical analysis module 364 which is used for converting the text file 350 into the teleconsultation parse tree 352. The lexical analysis module 364 has instructions for parsing the text file into tokens. The lexical analysis module also fills or generates a teleconsultation parse tree using the tokens. Also stored within the computer memory 346 is a syntactic analysis module 366. The syntactic analysis module converts the tokens 351 into the teleconsultation parse tree 352. Also contained within the computer memory 346 is a natural language generation module 368 which converts the teleconsultation parse tree 352 into a teleconsultation report 354. Also contained within the computer memory 346 is an outline creation module 370. The outline creation module 370 uses the patient record database 358 to create the teleconsultation outline 356.

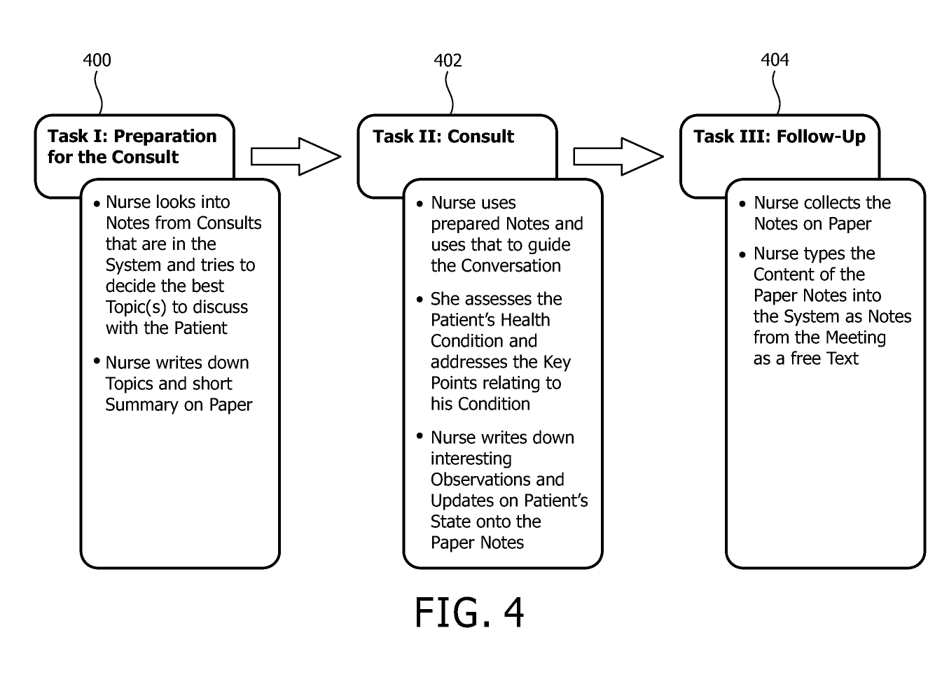

FIG. 4 shows the workflow that a nurse goes through for preparing for a teleconsultation with a patient. In step 400 the nurse prepares for the consultation. To prepare for the consultation the nurse looks into notes from consultations that are in the system and tries to decide the best topics to discuss with the patient. The nurse also writes down topics and a short summary on paper notes. The nurse first prepares for the teleconsultation by retrieving the patient file from the Motiva system and then browses though the notes from previous teleconsultations to find out what was discussed and what are key issues that should be addressed by the consult. Then she normally picks up the phone and calls the patient.

In step 402 the consultation with the patient takes place. During the consultation the nurse uses prepared notes and uses that to guide the consultation. The nurse also assesses the patient's health condition and addresses the key points relating to the patient's condition. The nurse also writes down interesting observations and updates the patient's state onto the paper notes. During the conversation she assesses how the patient is doing and based on this assessment she addresses a number of educational topics to ensure that the patient's condition improves. During the call she uses paper to write down most interesting observations for reporting purpose and also to know what has been changed in patient's health behavior.

In step 404 the nurse performs follow-up to the teleconsultation. In the follow-up the nurse collects the notes which have been written on the paper. Also during the follow-up the nurse types the content of the paper notes into the system as notes from the meeting as a free text. After the call, she collects all her notes and types them in the remote patient management system. These (manually taken) notes are used as the foundation for reporting of nurses actions and justifying the reasons of, for example, the referral of the patient to the specialist.

The described workflow is not unique only for nurse using telemonitoring systems. In fact all teleconsultations where the nurse calls the patient to discuss his/her condition over the phone follow the three outlined steps with the difference that the nurse interacts with the notes or data from the patient electronic patient record or the paper-based patient medical record. The same holds for the key aim of the teleconsultation to intervene and ensure that the patient is educated properly about his/her current condition, medications, lifestyle changes etc.

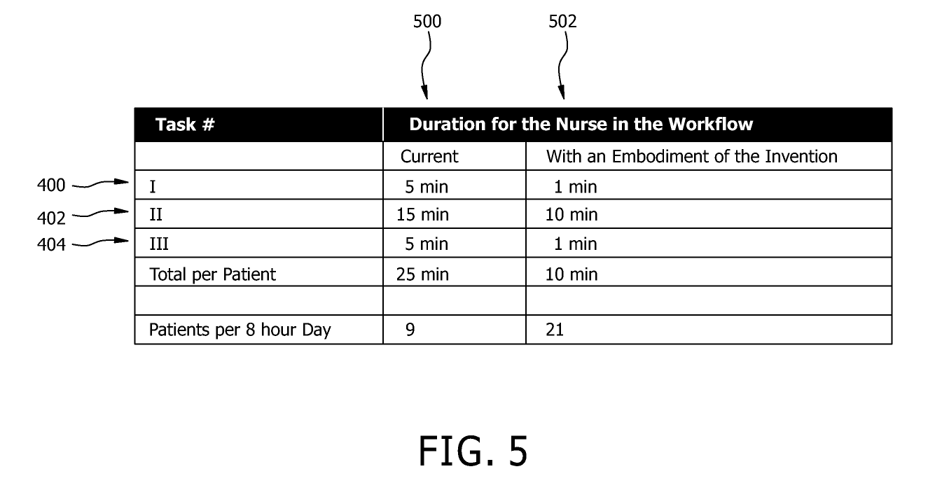

FIG. 5 shows a table which compares the method illustrated in FIG. 4 with a method according to an embodiment of the invention. Column 500 shows times for the method shown in FIG. 4 and column 502 shows the time for each step according to an embodiment of the invention. The tasks correspond to the items in FIG. 4. For instance for preparing for the consultation 400 the method illustrated in FIG. 4 takes five minutes whereas for an embodiment of the invention it takes only one minute. For consulting 402 the method shown in FIG. 4 takes 15 minutes whereas according to an embodiment of the invention it takes only 10 minutes. For the follow-up 404 the current method shown in FIG. 4 takes five minutes whereas for an embodiment of the invention it only takes one minute. This leads to a time saving of 15 minutes. During an eight hour day a nurse using the method shown in FIG. 4 can deal with only nine patients. Using an embodiment of the invention enables the nurse to perform 21 teleconsultations.

Currently, the key market differentiators for the remote patient management systems are:

support for the workflow of nurses so that out-patient centers or clinics find it more cost-effective to invest into the system and the RPM service to manage growing volume of patients than hiring many nurses, and

clinical benefits in terms of (i) intervening early to prevent hospitalization, and (ii) improving compliance to the treatment by offering the appropriate education to the patients.

Existing technical solutions enables the nurse to handle more patients than would normally be possible. However, when the nurse detects the deviations in the vitals or symptoms, the support of the system seizes and she prepares and calls the patient as she would without technology. Hence, we can observe the following key problems with current teleconsultations (with and without technology):

Problem which may be solved by embodiments of the invention: The nurse spends significant amount of her time to prepare, conduct and report the consultation. Estimation given in FIG. 5 shows that the amount of work spent on each task, limits the number of patients that the nurse can address during the day, directly influencing the profit as well as the quality of care of the healthcare institution. The nurses' actions are not reported such that her actions and information she gave can be used to generate reliable and objective report on how well her intervention works and what has happened during the consultation.

Additional problem which may be solved by embodiments of the invention: The nurse is never sure what the effect of the consultation was on the patient and how well the patient has retained the information she has provided. The retention of information is essential as the majority of her intervention is giving relevant educational information to the patient that can improve his compliance and clinical condition. The studies show low percent (approximately 10%) of retention if the information is communicated with speech.

Embodiments of the invention may potentially use uses speech to text conversion, natural language processing, and ontology matching to automatically generate a summary report of a (tele)consult, which can be used to support tasks of nurses as elaborated in FIG. 4 with the improvement in work efficiency as roughly estimated in FIG. 5.

Additionally, embodiments of the invention may potentially automatically send and/or plan a teaching quiz to the patient to assess the knowledge (retention) on topics discussed, and plans and/or sends a summary of the discussed matter to improve the retention of the content.

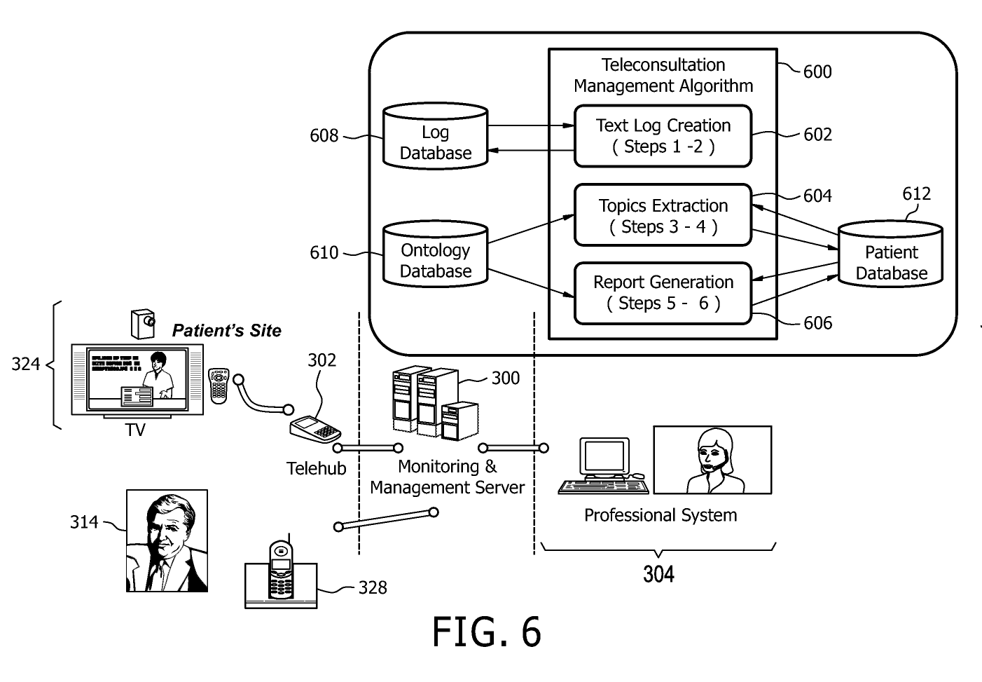

FIG. 6 shows a block diagram which illustrates a further embodiment of a remote patient management system according to the invention. The components of this remote patient management system corresponding to FIG. 3 have been labeled with identical numbers. In this embodiment the computing device 300 is a server and the health professional interface 304 is a separate computer system. The microphone 328 is a telephone system and the patient interface 324 comprises a television, a controller and a web camera.

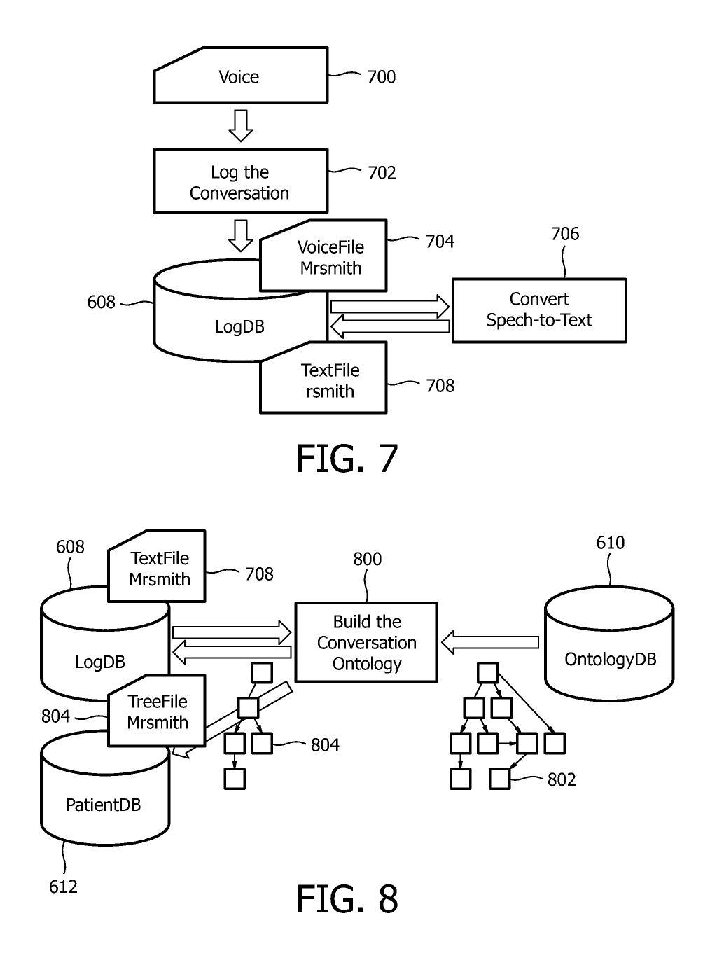

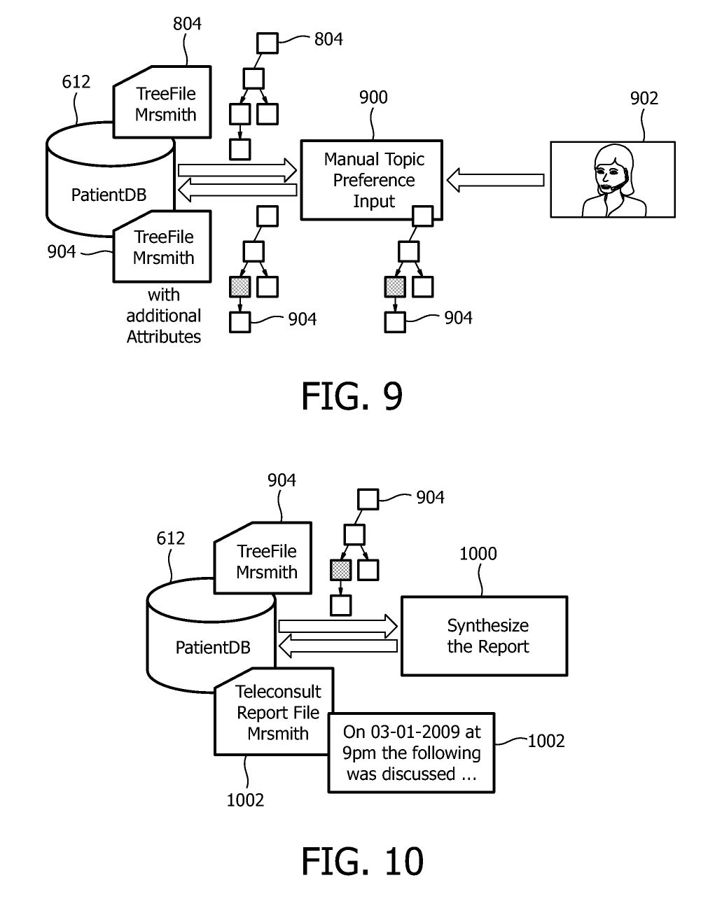

In FIG. 6 a teleconsultation management algorithm 600 according to an embodiment of the invention is illustrated. The algorithm is divided into six steps. The first two steps are represented by block 602. Block 602 is further explained below using FIG. 7. Block 604 deals with topic extraction and is explained in steps 3 and 4. Block 604 is explained in greater detail below using FIG. 8. Steps 5 and 6 is report generation and is represented by block 606 in FIG. 6. Block 606 is explained in greater detail in FIGS. 9-12 below. The computing device 300 is shown as also comprising a log database 608, an ontology database 610 and a patient database 612. The text log creation indicated by block 602 accesses the log database. The topic extraction illustrated by block 604 accesses the ontology database and exchanges information with the patient database 612. The report generation as illustrated in block 606 accesses information from the ontology database 610 and exchanges information with the patient database 612.

The use of an ontology database may be considered a form of syntactic analysis. Pattern recognition or pattern matching software may also be used as a substitute for the ontology database. A patient database 612 may also be referred to by the term parse tree database.

In FIG. 7 the process of creating a text file from a log of a voice recording of the teleconsultation is illustrated. The voice recording voice 700 is recorded and logged 702. The voice file 704 is recorded into the log database 608. A speech-to-text conversion algorithm 706 is used to generate a text file 708 from the audio file 704.

Step 1 [Log conversation] of FIG. 6, reference numeral 602: Log the conversation 700 to create a voice transcript that is stored in a voice file 704 (as shown in FIG. 7). The recording of speech is done at the professional end (e.g. telephone, microphone), and stored in the log database 608. Each entry in the database may be characterized by the following attributes: <Patient, Date, Time, Duration, VoiceFile, TextFile, TreeFile>, initially all empty.

Step 2 [Convert Speech-to-text] of FIG. 6, reference numeral 602: The voice file 704 is input to a speech-to-text algorithm 706, which makes a text transcript of the consult in a text file 708, and possibly stores the text file 708 in the log database 608 for future reference (cf. FIG. 7).

FIG. 8 illustrates how a conversation ontology is built or constructed. First the text file 708 of the conversation is accessed from the log database 608 by an ontology conversation algorithm 800. The ontology conversation algorithm 800 also accesses a ontology 802 from an ontology database 610 which is relevant to the disease of the patient.

The algorithm builds a teleconsultation parse tree 804 which is then logged into the patient database 612.

The text file 708 containing the transcript of the conversation is matched with the existing domain-ontology 802 for the disease in question as shown in FIG. 8. The domain ontology can be represented as a tree or acyclic graph, and may be annotated with: <NodeName, ShortDescription, Importance, RelationTo, Atributes, Presedence, IsChild>. These annotations are used to describe the relations between the nodes (RelationTo, IsChild, Presedence), as well as meaning of the node (NodeName, ShortDescription, Importance, Attributes).

FIG. 8 corresponds to Step 3 of FIG. 6, reference numeral 604. This step involves an algorithm 800 that traverses the domain-ontology tree node by node and does the matching of the nodes with the words in the text file thereby forming a tree or graph file 804 of the text transcript 708. The tree or graph file 804 may also be referred to as a teleconsultation parse tree 804. Each node of the created ontology file of the transcript may contains the following attributes: <NodeName, ShortDescription, Importance, RelationTo, Attributes, Presedence, IsChild>. The tree would then represent a main topic discussed with a number of sub-topics. The result of this step could be many trees, if a number of diverse topics were addressed during the conversation. The tree(s) are written back to the patient record/database. Moreover, the Importance of the node could be modified using the simple rule of counting the number of occurrences of that Node during the consult.

FIG. 9 illustrates how a healthcare professional can edit the teleconsultation parse tree. First the teleconsultation parse tree 804 is accessed from the patient database 612 by a manual preference input algorithm 900. Block 902 represents the receiving of edit data from the healthcare professional. 904 represents the edited teleconsultation parse tree which is then stored in the patient database 612.

FIG. 9 corresponds to Step 4 of FIG. 6, reference numeral 604. Step 4 is an optional manual preference input or edit: The nurse can override initial importance setting of a topic or a sub-topic via a health professional interface where the ontology tree 804 of the conversation is displayed as illustrated in FIG. 9. The modified trees 904 are written back to the patient record and or database.

FIG. 10 illustrates the synthesis or generation of a teleconsultation report. The teleconsultation parse tree 904 is accessed from the patient database 612. A report synthesis algorithm 1000 is used to generate the teleconsultation report 1002, which is subsequently stored in the patient database 612.

FIG. 10 corresponds to Step 5a of FIG. 6, reference numeral 606. Step 5a. In step 5a the teleconsultation report is synthesized or generated: The summary of the teleconsultation is generated by retrieving the teleconsultation parse tree 904 from the Patient database 612 and taking each node and its attributes to create a summary as shown in FIG. 10.

Step 5b, of FIG. 6 reference numeral 606, addresses patient follow-up after a teleconsultation. The list of discussed topics can be determined by an algorithm to send to the patient assessment questionnaires or summary of the content discussed. Follow-up by sending a summary of discussed content is done by looking in a content database for content regarding an instance in the list of discussed topics, and sending that to a telehealth system in the patient's home.

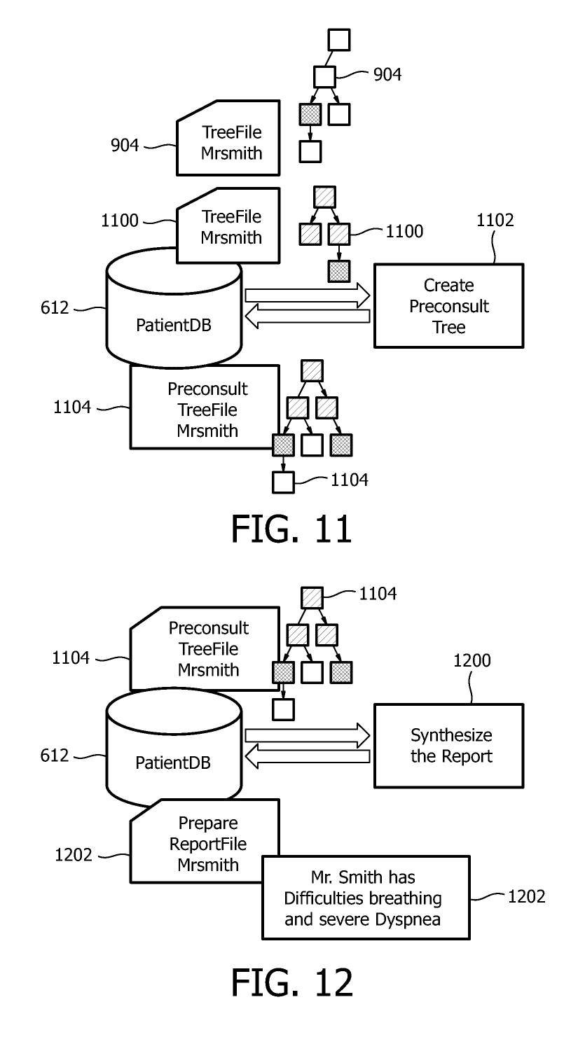

FIG. 11 illustrates how a teleconsultation outline may be constructed. The teleconsultation parse tree 904 and a previously logged teleconsultation parse tree 1100 are retrieved from the patient database 612. A teleconsultation outline creation algorithm 1102 joins these two trees together to form a pre-consult tree. A pre-consult tree may also be referred to as a preconsultation parse tree.

FIG. 11 corresponds to step 6a of FIG. 6, reference numeral 606. Step 6a describes the merging of multiple teleconsultation consultation parse trees 904, 1100 into a single preconsultation parse tree 1104: Frist a predetermined number of teleconsultation parse trees are retrieved from the patient database 612. A preconsultation parse tree 1104 may be created by comparing the relationships or annotation of the nodes of the trees 904, 1100 and merging them into one tree. By entering data into a healthcare professional interface, the nurse may also manually, if she desires, pick the reports she wants to be summarized into one report.

FIG. 12 illustrates how the pre-consult tree 1104 is used to generate the teleconsultation outline 1202. The pre-consult tree 1104 is accessed from the patient database 612 by a teleconsultation outline synthesis 1200. The subsequently generated teleconsultation outline 1202 is stored in the patient database 612.

FIG. 12 corresponds to step 6b of FIG. 6, reference numeral 606. In step Step 6b, the teleconsultation report 1202 is generated. The summary report is made by retrieving the tree from the Patient database and taking each node and its attributes to create a summary as shown in FIG. 12.

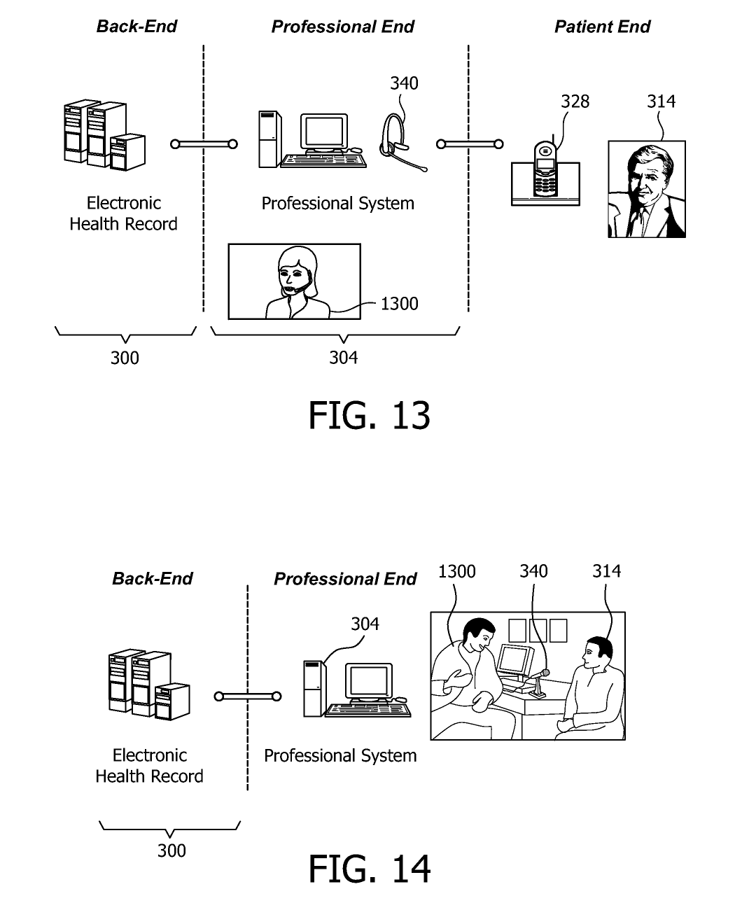

FIG. 13 shows a block diagram of a remote patient monitoring system according to an embodiment of the invention. In the embodiment shown in FIG. 13 it is a purely teleconsultation system which uses only a telephone 328 by the patient 314. In this embodiment the computing device is a server or a collection of computers 300 connected to a standalone computer 304 of the healthcare provider 1300. In this case the healthcare provider 1300 communicates to the patient 314 using a telephone 340. The patient 314 also communicates using a telephone 328. The software for operating the computing device 300 as shown in FIG. 3 may be distributed between the computing device 300 and the computer 304 of the healthcare professional 1300 in this embodiment.

FIG. 14 shows an embodiment of the invention useful for a face-to-face consultation. In this embodiment there is a computing device 300 and a computer 304 belonging to the healthcare professional 1300. In this case the healthcare professional 1300 and the patient 314 are together in the same room. In this case a single microphone 340 is used to record the speech of both the healthcare provider 1300 and the patient 314.

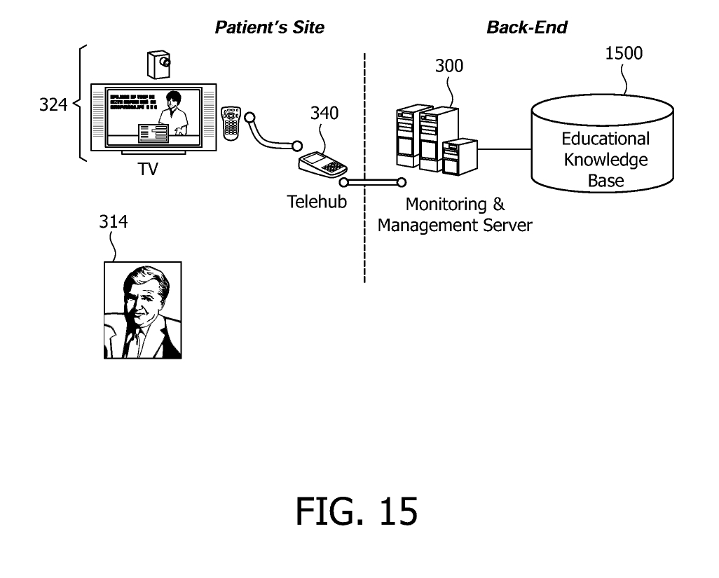

FIG. 15 shows a block diagram which illustrates a follow-up system for an embodiment of the invention. Shown is the computing device 300 which is connected to the home infrastructure device 302. The patient 314 is able to view content elements using the patient interface 324. The computing device 300 is also connected to an educational knowledge database 1500. The educational knowledge database 1500 contains content elements which may be used to reinforce those topics which were discussed during the teleconsultation.

While the invention has been illustrated and described in detail in the drawings and foregoing description, such illustration and description are to be considered illustrative or exemplary and not restrictive; the invention is not limited to the disclosed embodiments.

For example, it is possible to operate the invention in an embodiment wherein an algorithm can send a request for an assessment of patient knowledge or a request for content provision to the patient; an education knowledge base that holds both content and teaching quizzes and/or questionnaires; and a professional interface with a software module that enable the medical professional to highlight the importance of a topic.

Other variations to the disclosed embodiments can be understood and effected by those skilled in the art in practicing the claimed invention, from a study of the drawings, the disclosure, and the appended claims. In the claims, the word “comprising” does not exclude other elements or steps, and the indefinite article “a” or “an” does not exclude a plurality. A single processor or other unit may fulfill the functions of several items recited in the claims. The mere fact that certain measures are recited in mutually different dependent claims does not indicate that a combination of these measured cannot be used to advantage. A computer program may be stored/distributed on a suitable medium, such as an optical storage medium or a solid-state medium supplied together with or as part of other hardware, but may also be distributed in other forms, such as via the Internet or other wired or wireless telecommunication systems. Any reference signs in the claims should not be construed as limiting the scope.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

### LIST OF REFERENCE NUMERALS

300 computing device
302 home infrastructure device
304 healthcare professional interface
306 processor
308 computer memory
310 care plan
312 content element
314 patient
316 blood pressure cuff
318 scale
320 blood sugar measurement device
322 receptacle for blood
324 patient interface
326 display
327 text
328 microphone
330 display
332 graphical user interface
334 text
336 graphical user interface button
338 keyboard
340 microphone
342 processor
344 computer storage
346 computer memory
348 recording
350 text file
351 tokens
352 teleconsultation parse tree
354 teleconsultation report
356 teleconsultation outline
358 patient record database
360 operation module
362 speech recognition module
364 lexical analysis module
366 syntactic analysis module
368 natural langue generation module
370 outline creation module
400 preparation for the teleconsultation
402 teleconsultation
404 follow-up to teleconsultation
500 method as described in FIG. 4
502 method according to an embodiment of the invention
600 teleconsultation management algorithm
602 text and log creation
604 topic extraction
606 report generation
608 log database
610 ontology database
612 patient database
700 voice conversation
702 record the conversation
704 voice file
706 convert speech-to-text
708 text file comprising a transcript of the conversation
800 build the conversation ontology
802 teleconsultation parse tree from ontology database
804 filled teleconsultation parse tree
900 algorithm for receiving edit data
902 receiving edit data
904 edited teleconsultation parse tree
1000 teleconsultation report generation algorithm
1002 teleconsultation report
1100 teleconsultation parse tree from parse tree database
1102 pre-consultation parse tree joining algorithm
1104 pre-consultation parse tree
1200 teleconsultation generation algorithm
1202 teleconsultation outline
1300 healthcare provider
1500 education knowledge database

What is claimed is:

1. A remote patient management system comprising a computing device, wherein the computing device comprises a processor, wherein the computing device further comprises a computer-readable storage medium containing instructions that when executed cause the processor to perform a method of generating a teleconsultation report, the method comprising the steps of:
recording a teleconsultation between a health professional and a patient using a microphone;
converting the recording of the teleconsultation into a text file;
parsing the text file into tokens;
filling a teleconsultation parse tree using the tokens, wherein the teleconsultation parse tree has nodes arranged in a tree like structure; and
generate the teleconsultation report using the teleconsultation parse tree.

2. The remote patient management system of claim 1, wherein the remote patient management system further comprises a home infrastructure device, wherein the home infrastructure device comprises at least one diagnostic medical device for measuring a value of a patient vital sign; and wherein the method of generating a teleconsultation report is initiated when the value of a patient vital sign is outside of a predetermined range.

3. The remote patient management system of claim 1, wherein the remote patient monitoring system further comprises a health professional interface, wherein the method further comprises displaying a teleconsultation outline on the health professional interface during the recording of the conversation.

4. The remote patient management system of claim 3, wherein the teleconsultation outline comprises questions and/or list of topics to be discussed with the patient.

5. The remote patient management system of claim 4, wherein the teleconsultation parse tree is at least partially created using the teleconsultation outline.

6. The remote patient management system of claim 3, wherein the remote patient monitoring system further comprises a patient record database with a patient record belonging to the patient, wherein the patient record comprises a parse tree database, wherein the parse tree database comprises a plurality of teleconsultation parse trees, wherein the method further comprises constructing a pre-consultation parse tree at least partially by combining a predetermined number of teleconsultation parse trees from the parse tree database, wherein the method further comprises the step of generating a teleconsultation outline using the pre-consultation parse tree.

7. The remote patient management system of claim 6, wherein the method further comprises the step of adding the filled teleconsultation parse tree to the parse tree database.

8. The remote patient management system of claim 1, wherein the teleconsultation report is generated using a natural language generation system to convert the teleconsultation parse tree into the teleconsultation report.

9. The remote patient management system of claim 1, wherein the method further comprises receiving edit data before generating the teleconsultation report; wherein the edit data comprises instructions for editing the teleconsultation parse tree; and wherein the method further comprises the step of editing the teleconsultation parse tree using the edit data.

10. The remote patient management system of claim 1, wherein the remote patient management system further comprises a home infrastructure device, wherein the home infrastructure device comprises at least one diagnostic medical device for measuring a value of a patient vital sign; wherein the method further comprises measuring the effectiveness of the teleconsultation using the home infrastructure device.

11. The remote patient management system of claim 10, wherein the effectiveness of the teleconsultation is measured at least partially by tracking the value of a patient vital sign for a predetermined amount of time.

12. The remote patient management system of claim 10, wherein the effectiveness of the teleconsultation is measured at least partially using a quiz, wherein the quiz comprises questions at least partially selected using the teleconsultation parse tree, wherein the method further comprises delivering the quiz to the home infrastructure device, wherein the method further comprises presenting the quiz to the patient using the home infrastructure device, wherein the method further comprises scoring the quiz to measure the effectiveness of the teleconsultation.

13. The remote patient management system of claim 1, wherein the remote patient management system further comprises a home infrastructure device, wherein the home infrastructure device comprises at least one diagnostic medical device for measuring a value of a patient vital sign; wherein the method further comprises delivering educational content to the home infrastructure selected using the teleconsultation parse tree.

14. The remote patient management system of claim 1, wherein the recording of the conversation comprises at least two time synchronized recordings, wherein one of the time synchronized recordings contains a recording of only one of: the patient or the health care professional.

15. The remote patient management system of claim 1, wherein the parse tree is implemented in extensible markup language.

16. The remote patient management system of claim 1, wherein the nodes are annotated nodes.

17. A computer readable storage medium having stored therein instructions, which when executed by a computing device comprising a processor cause the computing device to perform a method of generating a teleconsultation report, the method comprising the steps of:
recording a teleconsultation between a health professional and a patient using a microphone;
converting the recording of the teleconsultation into a text file;
parsing the text file into tokens;
filling a teleconsultation parse tree using the tokens, wherein the teleconsultation parse tree has nodes arranged in a tree like structure; and
generate the teleconsultation report using the teleconsultation parse tree.

18. A computer implemented method of generating a teleconsultation report, the method comprising the steps of:
recording a teleconsultation between a health professional and a patient using a microphone;
converting the recording of the teleconsultation into a text file;
parsing the text file into tokens;
filling a teleconsultation parse tree using the tokens, wherein the teleconsultation parse tree has nodes arranged in a tree like structure; and
generate the teleconsultation report using the teleconsultation parse tree.
